(19) United States
(12) Patent Application Publication
(10) Pub. No.: US 2023/0186014 A1
(43) Pub. Date: Jun. 15, 2023

(54) METHODS FOR WEB-TO-PRINT MULTIPLE OVERFLOW PAGINATION

(71) Applicant: Salesforce.com, Inc., San Francisco, CA (US)

(72) Inventors: Angela LIU, San Francisco, CA (US); Dai Duong DOAN, Alameda, CA (US); Alex YE, San Francisco, CA (US); Pei CHU, San Francisco, CA (US); Keye LIU, San Francisco, CA (US); Kaidi XU, San Francisco, CA (US); Limor ROHALD, Petah Tikva (IL); Puneet DHALIWAL, Hayward, CA (US); Shanis KURUNDRAYIL, San Francisco, CA (US); Tyler SHOPSHIRE, San Francisco, CA (US)

(73) Assignee: Salesforce.com, Inc., San Francisco, CA (US)

(21) Appl. No.: 17/643,575

(22) Filed: Dec. 9, 2021

(51) Int. Cl. G06F 40/14; G06F 3/12; G06F 40/166

(52) U.S. Cl. CPC G06F 40/14; G06F 3/1272; G06F 3/1204; G06F 3/1246; G06F 40/166

(57) ABSTRACT

Disclosed are some implementations of systems, apparatus, methods and computer program products for handling multiple overflows of content during pagination of a web document. A first tree representing a web document is obtained. A first page element including one or more elements of the first tree is generated, where the elements include a first Document Object Model (DOM) element. Coordinates of the first DOM element within the first page element are calculated. A first context associated with the first DOM element is pushed onto a context stack. An overflow of the first DOM element is detected in relation to the first page element based, at least in part, on the coordinates. Responsive to detecting the overflow, the context stack is added to an overflow list and the first page element is modified such that the first DOM element or portion thereof is removed from the first page element. A second page element is generated based, at least in part, on the overflow list such that the second page element includes the first DOM element.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to systems and techniques for facilitating pagination of a web document. More specifically, this patent document discloses techniques for managing multiple overflows of content during pagination of a web document.

### BACKGROUND

It is often desirable to print web documents for a variety of purposes. For a web document containing a single column of text, the print process is relatively straightforward. However, for a web document having side-by-side content (e.g., an image placed next to text or multiple columns), the format of a printed document can differ substantially from that originally intended.

### BRIEF DESCRIPTION OF THE DRAWINGS

The included drawings are for illustrative purposes and serve only to provide examples of possible structures and operations for the disclosed systems, apparatus, methods and computer program products for facilitating implementation of a web-to-print system. These drawings in no way limit any changes in form and detail that may be made by one skilled in the art without departing from the spirit and scope of the disclosed implementations.

FIG. 1 shows a system diagram of an example of a system 100 in which web-to-print methods can be implemented, in accordance with some implementations.

FIG. 2 is a diagram of an example computing system 200 that may be used with some implementations.

FIG. 3A show an example web document 300 that may be printed, in accordance with some implementations.

FIG. 3B shows an example of print output 330 that is generated from the web document 300 of FIG. 3A according to conventional printing methods.

FIG. 3C shows an example of print output 360 resulting from pagination of the web document 300 of FIG. 3A, in accordance with some implementations.

FIG. 4A shows an example Document Object Model (DOM) tree 400 and corresponding print output, in accordance with various implementations.

FIG. 4B shows an example overflow list 430 that may be implemented, in accordance with various implementations.

FIG. 4C shows an example tree 460 having properties indicating whether rendering has been completed for corresponding DOM elements, in accordance with various implementations.

FIG. 5A shows a process flow diagram 500 illustrating a method of implementing a web-to-print system, in accordance with various implementations.

FIG. 5B shows a process flow diagram 550 illustrating a method of setting property values of DOM elements in accordance with various implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram of an example of architectural components of an on-demand database service environment 900, in accordance with some implementations.

FIG. 7B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured to implement a web-to-print system. In some implementations, systems, apparatus, methods, and computer program products are configured to manage overflows that occur during pagination of a web document

Today, web documents are accessed via the Internet for a variety of purposes. A web document can include various types of components including, but not limited to, text, images, tabs, and multi-column tables. In addition, web developers have the ability to build and use custom components.

Often, users want to print web documents. While it is possible to paginate a web document for printing, the pagination of a web document is complicated by the fact that the web document can include any number of components, which may be of various types and may be positioned at different locations with respect to one another within the web document. Unfortunately, converting a web document to paged paper of any size and orientation can be challenging.

Current print technology enables a single overflow of a column of text to be tracked, enabling the remaining text that “overflows” a page to be printed on the next page. While this solution can be applied to successfully paginate a single column of text, the technology cannot accurately paginate web documents having a more complex format such as side-by-side content including text and an image or, alternatively, a table having multiple columns.

Typically, when a web browser accesses a web document, it parses the Hypertext Markup Language (HTML) and builds a Document Object Model (DOM) tree having nodes corresponding to DOM elements of the web document. In addition, the web browser parses Cascading Style Sheets (CSS) code so that it can build a CSS Object Model (CSSOM) tree. The CSSOM and DOM trees can be combined into a render tree, which is then used to compute the layout of every visible element of the web document, which is rendered to a screen.

In accordance with various implementations, a copy of the original “active” render tree is traversed to paginate the web document while disconnecting the corresponding document fragment from the active document tree. By traversing a copy of the render tree rather than the original render tree, this prevents the document from being rendered until the pagination is completed. During the traversal, page elements representing corresponding printed pages are generated and appended to the active render tree, enabling the correctly formatted pages to be printed.

In accordance with various implementations, multiple overflow points can be handled in a manner that preserves the formatting of the original web document within the printed document. This is accomplished, at least in part, by generating page elements that correspond to printed pages and saving a context of the DOM elements that do not fit on the current page element within an overflow list. These DOM elements may also be referred to as overflow elements. By saving the context of the overflow elements in an overflow list, the overflow list may be used to present and format the overflow elements on the subsequent page element (e.g, while rebuilding the active DOM or render tree).

The context of an overflow element may identify the overflow element. In addition, the context of an overflow element can specify or otherwise indicate a context type of the corresponding DOM element. The context type may be determined based, at least in part, on a type of the overflow element, which can be ascertained based on a value of a Hypertext Markup Language (HTML) property or CSS property of the DOM element. In addition, the context of an overflow element can identify non-ancestor element(s) of the overflow element (e.g., sibling and descendant elements) that also are to be rebuilt (e.g., cloned) in the next page along with the DOM element. Each type of context (or type of DOM element) may be associated with a corresponding set of rules that is used to present and format the corresponding DOM element and any associated non-ancestor elements within a page element.

In accordance with various implementations, the disclosed web document pagination system is extensible to accommodate various DOM element types. As additional (e.g., custom) component types and associated DOM element types supported by the system are expanded, the context types that are identifiable by the system may similarly be expanded or otherwise modified. For each additional context type supported by the system, a corresponding set of rules can be configured and stored in association with the context type.

When multiple overflow points are tracked, there is the possibility of accidentally re-rendering the same element multiple times. An example of this is when there are two flex columns and two overflow points are tracked.

Since a given DOM element can be traversed multiple times during the rendering of a web document, it is desirable to track when the rendering for a given DOM element is completed (e.g., there is no content overflow from a prior page). In some implementations, a done rendering property is maintained for DOM elements of specific types (e.g., within the copy of the render tree being traversed). The value or state of the done rendering property for a given DOM element indicates whether rendering for that DOM element is completed. For those DOM elements that do not have a corresponding done rendering property, the equivalent value of a done rendering property of a parent node may be determined based upon the value of the done rendering property of each of its children.

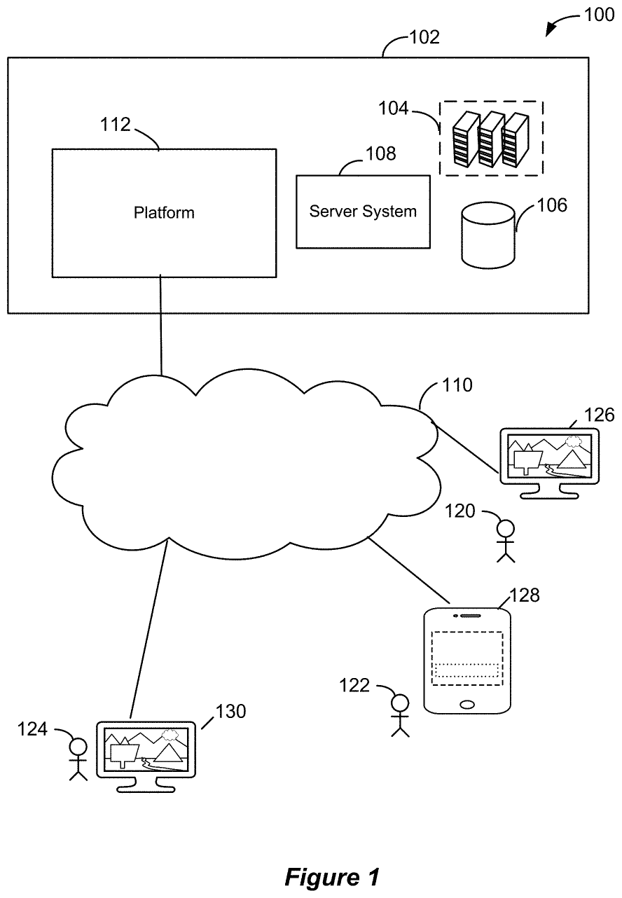

FIG. 1 shows a system diagram of an example of a system 100 in which a web-to-print methods can be implemented, in accordance with some implementations. Database system 102 includes a variety of different hardware and/or software components that are in communication with each other. In the non-limiting example of FIG. 1, system 102 includes any number of computing devices such as servers 104. Servers 104 can include one or more web servers configurable to execute web applications. Servers 104 are in communication with one or more storage mediums 106 configured to store and maintain relevant data and/or metadata used to perform some of the techniques disclosed herein, as well as to store and maintain relevant data and/or metadata generated by the techniques disclosed herein. Storage mediums 106 may further store computer-readable instructions configured to perform some of the techniques described herein. Storage mediums 106 can also store user accounts/user profiles of users of system 100, as well as database records such as customer relationship management (CRM) records.

System 102 includes server system 108, as described herein. More particularly, server system 108 supports the generation of web documents, which can include data retrieved from one or more database records.

In some implementations, system 102 is configured to store user profiles/user accounts associated with users of system 102. Information maintained in a user profile of a user can include a client identifier such an Internet Protocol (IP) address or Media Access Control (MAC) address. In addition, the information can include a unique user identifier such as an alpha-numerical identifier, the user's name, a user email address, and credentials of the user. Credentials of the user can include a username and password. The information can further include job related information such as a job title, role, group, department, organization, and/or experience level, as well as any associated permissions. Profile information such as job related information and any associated permissions can be applied by system 102 to manage access to web applications or services such as those described herein.

Client devices 126, 128, 130 may be in communication with system 102 via network 110. More particularly, client devices 126, 128, 130 may communicate with servers 104 via network 110. For example, network 110 can be the Internet. In another example, network 110 comprises one or more local area networks (LAN) in communication with one or more wide area networks (WAN) such as the Internet.

Embodiments described herein are often implemented in a cloud computing environment, in which network 110, servers 104, and possible additional apparatus and systems such as multi-tenant databases may all be considered part of the “cloud.” Servers 104 may be associated with a network domain, such as www.salesforce.com and may be controlled by a data provider associated with the network domain. In this example, employee users 120, 122, 124 of client computing devices 126, 128, 130 have accounts at salesforce.com®. By logging into their accounts, users 126, 128, 130 can access the various services and data provided by system 102 to employees. In other implementations, users 120, 122, 124 need not be employees of salesforce.com® or log into accounts to access services and data provided by system 102. Examples of devices used by users include, but are not limited to, a desktop computer or portable electronic device such as a smartphone, a tablet, a laptop, a wearable device such as Google Glass®, another optical head-mounted display (OHMD) device, a smart watch, etc.

In some implementations, users 120, 122, 124 of client devices 126, 128, 130 can access services provided by system 102 via platform 112 or an application installed on client devices 126, 128, 130. More particularly, client devices 126, 128, 130 can log into system 102 via an application programming interface (API) or via a graphical user interface (GUI) using credentials of corresponding users 120, 122, 124 respectively. Client devices 126, 128, 130 can communicate with system 102 via platform 112. Communications between client devices 126, 128, 130 and system 102 can be initiated by a user 120, 122, 124. Alternatively, communications can be initiated by system 102 and/or application(s) installed on client devices 126, 128, 130. Therefore, communications between client devices 126, 128, 130 and system 102 can be initiated automatically or responsive to a user request.

A web application executing via system 102 can generate web documents. Client devices 126, 128, 130 can access the web application and web documents via platform 112.

Some implementations may be described in the general context of computing system executable instructions, such as program modules, being executed by a computer. The disclosed implementations may further include objects, data structures, and/or metadata, which may facilitate the implementation of an intent driven system, as described herein.

Some implementations may also be practiced in distributed computing environments where tasks are performed by remote processing devices that are linked through a communications network. In a distributed computing environment, program modules may be located in local and/or remote computer storage media including memory storage devices.

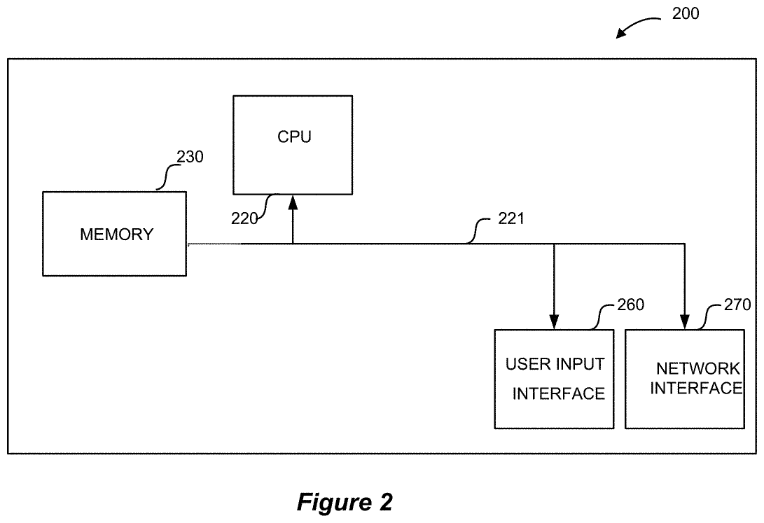

A computing device that operates as a server or client device may be implemented via any suitable computing system. FIG. 2 is a diagram of an example computing system 200 that may be used with some implementations. Computing system 200 may include a central processing unit (CPU) 320 having one or more processing cores and a memory 230. In addition, computing system 200 may include a system bus 221 that couples with various system components including the memory 230 and the CPU 220.

In some implementations, computing system 200 includes a variety of computer program products. A computer program product can be any available media that can be accessed by computing system 200 including, but not limited to, volatile and nonvolatile media, removable and non-removable media. A computer program product may store information such as computer readable instructions, data structures, or other data such as that described herein.

Memory 230 may include read only memory (ROM)) and/or random- access memory (RAM). In some implementations, memory 230 stores computer readable instructions, data structures, and/or data, which may be generated or processed as described herein.

In some implementations, a user may interact with the computing system 200 through an input device such as a keyboard, a microphone, a remote control, and/or a pointing device such as a mouse, touch pad, or touch screen. These and other input devices may be connected to the CPU 220 through a user input interface 260. Alternatively, an input device may be connected to computing system 200 by another interface such as a universal serial bus (USB) port or wireless interface.

Computing system 200 may operate in a networked environment via which it may connect to a system such as that described above with reference to FIG. 1. Computing system 200 may be connected to a local or wide area network through a network interface or adapter 270.

A web browser of computing system 200 can implement a web-to-print method, as described herein. To illustrate the advantages of the disclosed implementations, the results of a conventional print output will be described in further detail below.

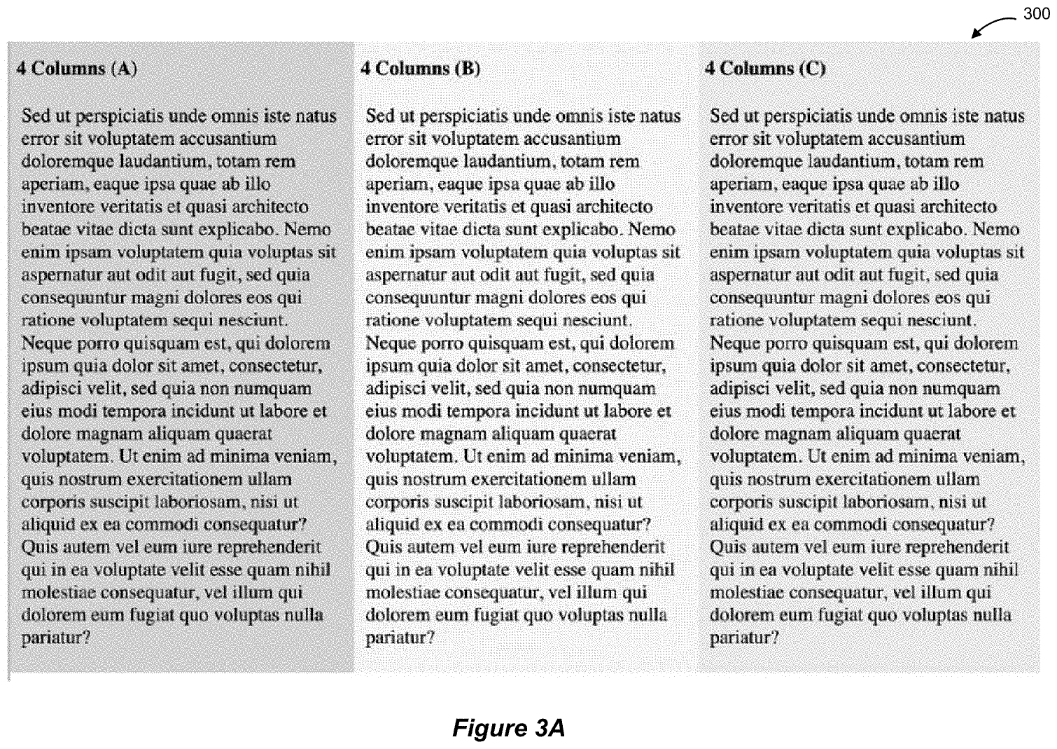

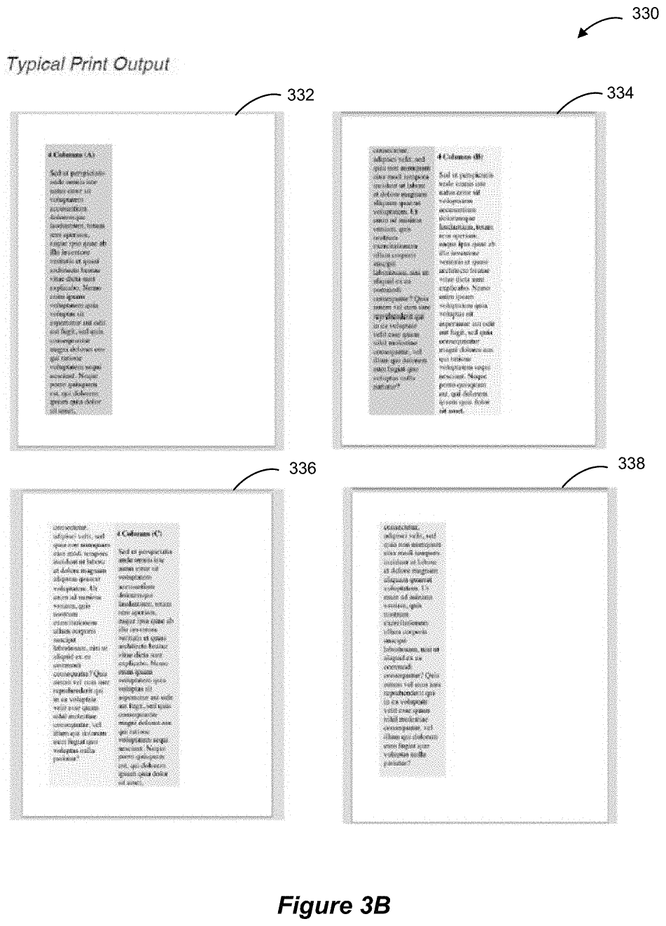

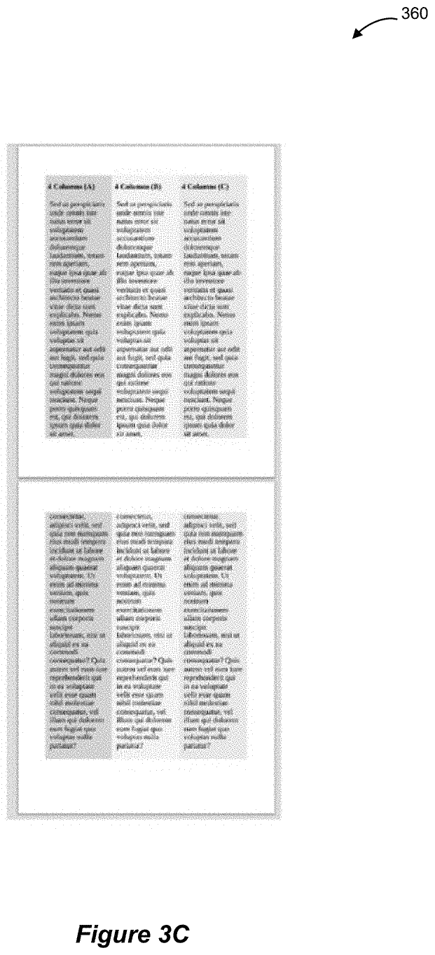

FIG. 3A show an example web document 300 that may be printed, in accordance with some implementations. Generally when a user chooses to print a web document, the user expects that the web document will be printed in the same format in which it is rendered on their screen. While the printed document will be formatted correctly if the web document consists of a single column of text, the resulting printed document is often formatted incorrectly for documents having side-by-side content (e.g., an image placed next, multiple columns). Therefore, the resulting format of a printed document can differ dramatically from that originally intended

Typically, a conventional web printing algorithm tracks a single “overflow point” between pages to influence building the next page. Therefore, the web printing algorithm can accurately calculate the overflow point for a single, unbroken column of text.

FIG. 3B shows an example of print output 330 that is generated from the web document 300 of FIG. 3A according to conventional printing methods. As shown in this example, an overflow of the first, left-hand column, column A, of the web document 300 can be handled, enabling the first portion of this column to be printed on a first printed page 332 and the remaining portion of the column to be printed on a second printed page 334. Unfortunately, current technology cannot handle the overflow of multiple columns or components of a web page during pagination of the web document.

As shown in this example, the remaining columns of text in the web document 300 (columns B and C) are formatted incorrectly within the printed pages 332, 334, 336, 338 shown in FIG. 3B. More particularly, the first printed page 332 includes only a portion of the first column, column A, and does not include portions of columns B and C. Rather, because only a single overflow can be tracked using conventional pagination methods, the second column, column B, is split between pages 334 and 336 while the third column, column C, is split between pages 336 and 338.

Even if multiple overflow points were tracked using current print technology, there fails to be a mechanism for properly handling the many different types of content that can overflow onto the next page. Moreover, since a document tree representing a HyperText Markup Language (HTML) document can contain nested structures, correctly paginating such a document is a difficult and complex process.

In accordance with various implementations, multiple overflow points may be simultaneously tracked using data structures including a context stack and overflow list. FIG. 3C shows an example of print output 360 resulting from pagination of the web document 300 of FIG. 3A, in accordance with some implementations. As shown in this example, the overflow of each of the columns, columns A, B, and C of the original document 300 can be separately tracked, enabling the top portion of columns A, B, and C to be rendered on a first printed page and the lower portion of columns A, B, and C to be rendered on a second printed page.

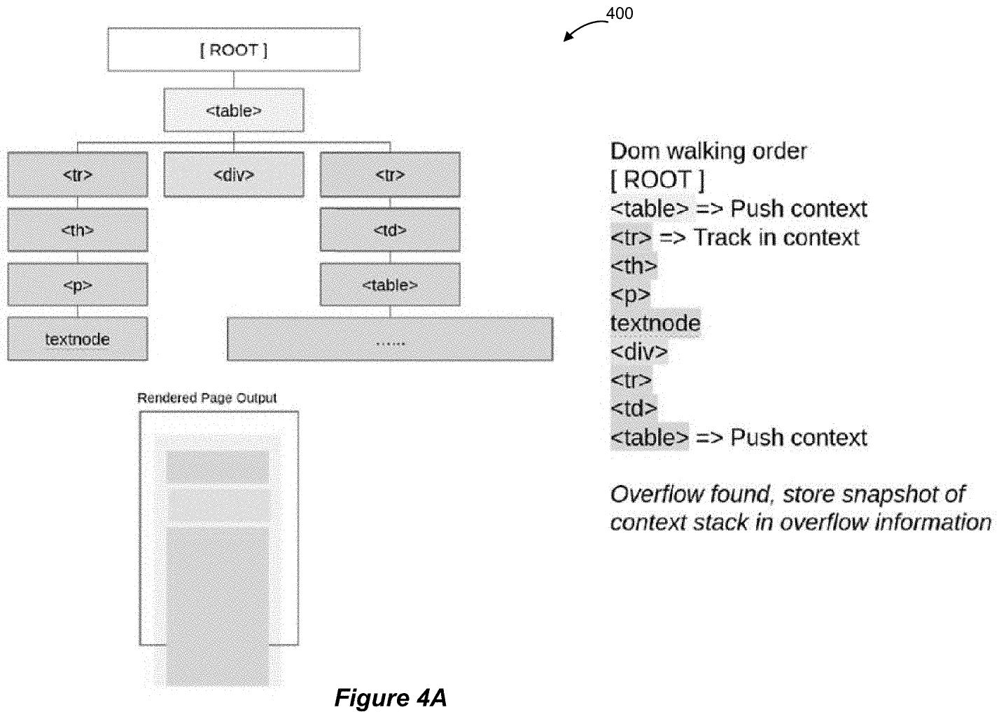

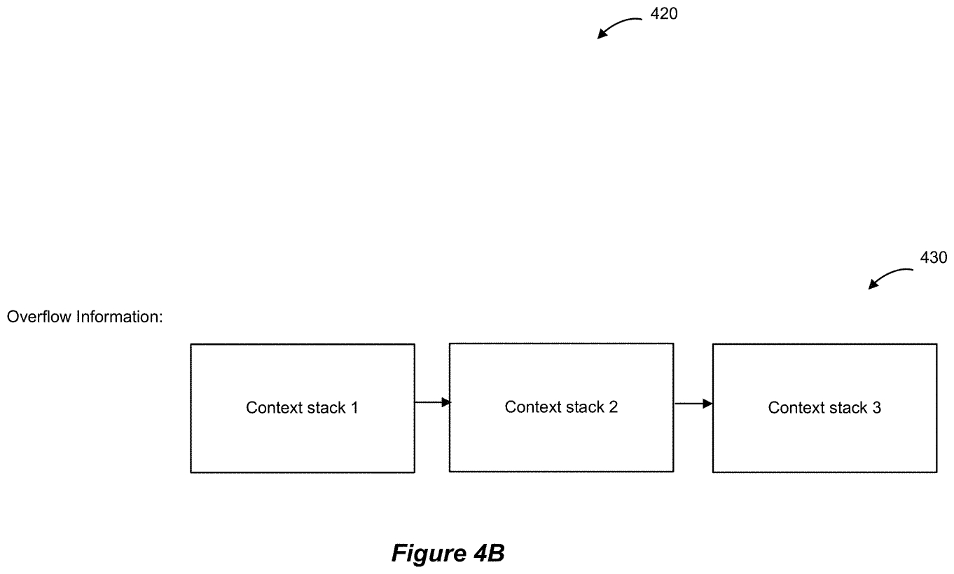

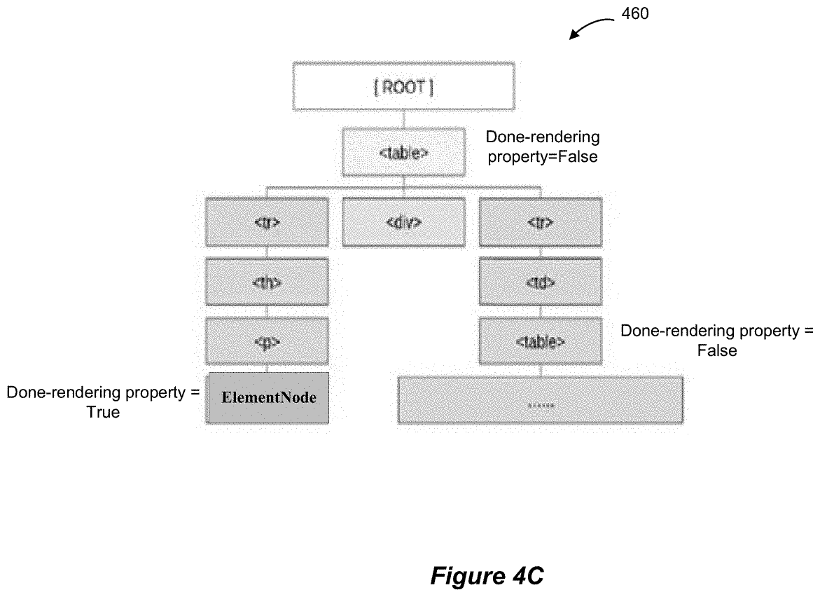

In accordance with various implementations, pagination is performed using a tree data structure that is generated from the web document. FIG. 4A shows an example DOM tree 400 and corresponding print output, in accordance with various implementations. As shown in this example, the tree data structure includes nodes representing elements of the web document. More particularly, the tree data structure includes a root node having one or more child nodes. Each child node can similarly have its own set of child nodes. Nodes within the tree are linked to one another via “branches.” For example, the tree data structure can include a pointer that links a parent to a child node.

Nodes within the tree data structure can represent DOM elements of the web document. In addition, the tree data structure can include CSS information (not shown to simplify illustration) of the web document. The tree data structure may be referred to as a DOM tree or render tree.

During the pagination and associated print formatting of a web document, nodes of the tree are traversed beginning at the root node. As the tree is traversed, a context associated with a corresponding DOM element is pushed onto a context stack. If an overflow point is detected for a DOM element, a snapshot of the context stack is saved in overflow information, which may be referred to as an overflow list.

FIG. 4B shows an example overflow list 430 that may be implemented, in accordance with various implementations. As shown in this example, an overflow list can include any number of elements, where each element of the overflow list corresponds to a DOM element for which an “overflow point” is detected. The overflow list may be implemented, for example, via an array or linked list data structure.

Context information that is stored in an element of the overflow list can identify the overflow element (the DOM element where the context begins). In addition, the context information can specify or otherwise indicate a type of context associated with the DOM element. The context type may be determined based, at least in part, on a type of the DOM element (e.g., table, text, etc.) and/or value of one or more CSS properties. The context information can also identify non-ancestors (e.g., descendant and/or sibling DOM elements), if any) of the DOM element (e.g., if pertinent to the context type). As will be described in further detail below, the context type (e.g., type of the DOM element) can be used to identify a set of rules that guides the rendering (e.g., formatting) of the DOM element and its sibling elements (if any) within a page element.

Each context type associated with a DOM element may be associated with a set of rules that dictates, for the context type: 1) what content is to be rebuilt on the next page for the DOM element (if it is determined to be an overflow element) and 2) how that content is to be rebuilt on the next page for the DOM element (if it is determined to be an overflow element). In other words, the set of rules dictates the format in which the content being rebuilt is to be presented on the next page.

Example context types include: 1) Base—a generic HTML element (e.g., text, image) that does not require special building; 2) Flex 13 an HTML element that implements CSS flex styling (e.g., .slds grid) for creating columns, which includes the cloning of all sibling columns (whether empty or not); 3) Table—a <table> element for which all table header elements are cloned (in addition to the table element); 4) Table Row—a <tr> element for which all sibling columns are cloned (in addition to the table row) and 4) Field/Value—An HTML element labeled by a field, which includes potentially rebuilding a label of the field on the next page.

In accordance with various implementations, a done rendering property of a DOM element is set to indicate whether rendering for the DOM element is completed. FIG. 4C shows an example tree 460 having properties indicating whether rendering has been completed for corresponding DOM elements, in accordance with various implementations. As shown in this example, a value of the done rendering property for a DOM element, “ElementNode,” is set to indicate that rendering is completed (e.g., TRUE or 1) for the DOM element while the value of the done rendering property for the DOM element, <table>, indicates that rendering is not completed (e.g., FALSE or 0) for the DOM element. In some implementations, the value of the done rendering property for DOM elements of the tree is initialized to a default value (e.g., FALSE or 0) that indicates that rendering for the corresponding DOM element is not completed.

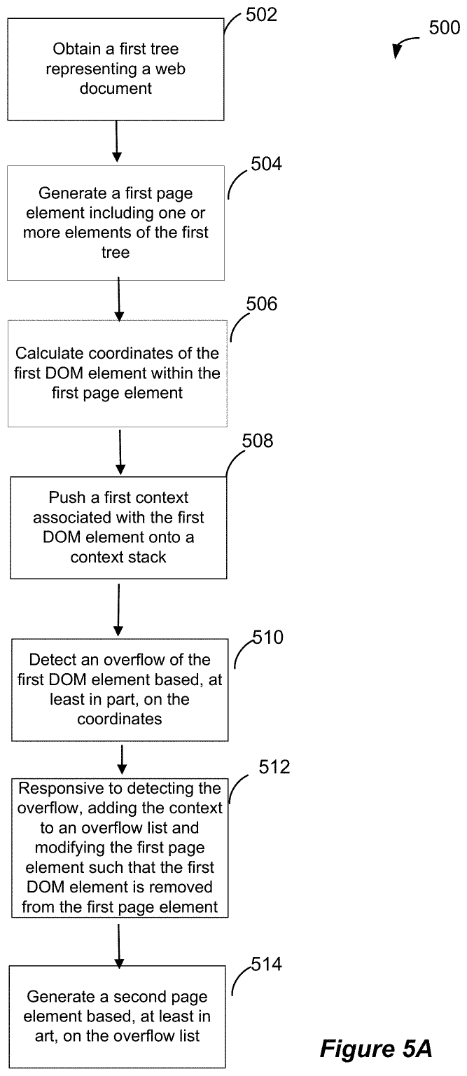

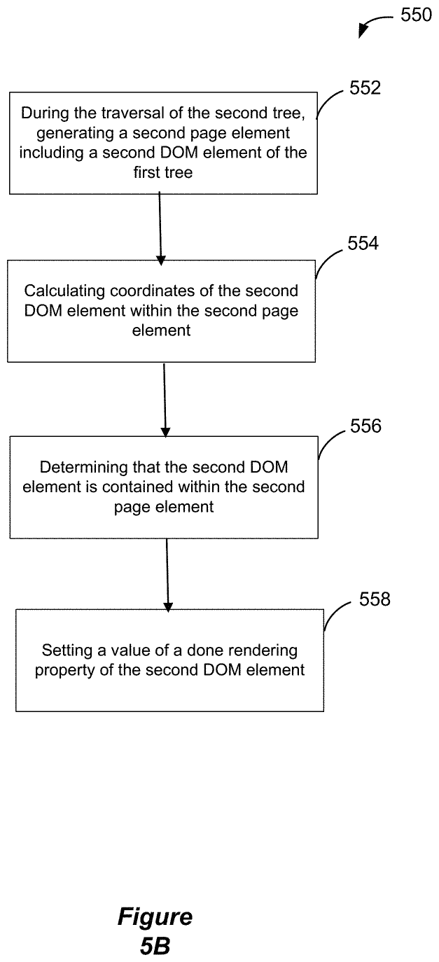

In accordance with various implementations, the web document is paginated for printing by a web browser of a computing device. An example method of paginating a web document will be described in further detail below with reference to FIGS. 5A-5B.

FIG. 5A shows a process flow diagram 500 illustrating a method of implementing a web-to-print system, in accordance with various implementations. A first tree representing a web document (e.g., web page) associated with a web address is obtained 502, where the first tree includes one or more DOM elements. In addition, the first tree can include Cascading Style Sheets (CSS) information pertaining to the DOM elements. The first tree can include the original “active” DOM or render tree or, alternatively, the first tree can include a copy of the DOM or render tree.

In some implementations, the original DOM or render tree is detached or disconnected from the active DOM tree (i.e., render tree). The detached document fragment can then be stored in a separate location (e.g., in a variable) so that it is not actively rendered as it is traversed. A tree including the detached document fragment or copy of the document fragment can then be traversed without rendering the content within it. By traversing the tree including detached document fragment (or copy thereof) rather than the original “active” tree, it is possible to paginate the web document before it is printed.

A first page element including one or more elements of the first tree is generated at 504, where the one or more elements include a first DOM element. In other words, a page element is created and elements from the original DOM or render tree are cloned and added to the first page element. For example, the tree including the detached fragment or copy thereof can be traversed to copy elements of the tree to the first page element. Therefore, the first page element represents a first printed page of the web document.

As page elements representing printed pages are built, they can be added, inserted, or appended to the active DOM tree (i.e., render tree) so that they can later be rendered during printing. For example, the first page element can be inserted into the first tree so that it can later be rendered. The elements of the first page element may be walked (e.g., traversed) to determine whether they fit in the first page element. More particularly, coordinates of the first DOM element within the first page element are calculated at 506 using the corresponding CSS information so that the coordinates of the first DOM element can be compared to the bounds of the first page element. In some implementations, the bounds of the first page element may vary depending upon the size of the page being printed, size of the font, etc.

In addition, a first context associated with the first DOM element is pushed onto a context stack at 508. More particularly, the first context can identify the first DOM element for which the overflow was detected and a type of context (or type of DOM element) for the first DOM element. The type of context may be determined based, at least in part, on a value of one or more HTML properties of the first DOM element. The first context can also specify an index indicating the position within the first page element at which the overflow was detected. In addition, the first context can identify any non-ancestor elements (e.g., sibling and/or descendant elements) of the first DOM element (e.g., if pertinent to the type of context). Therefore, the first context stack represents a snapshot at which the overflow point has been detected.

The set of rules associated with a given context type (or element type) may govern those non-ancestor elements (e.g., sibling or decendent elements) that are to be tracked within the context. For example, for a “table context,” there may be a rule that dictates that a header element be repeated across multiple pages. Therefore, the set of rules can specify the types of elements that are to be tracked within the context of a DOM element of the context type (and whether and in what format those types of elements are to be reproduced across pages).

Using the coordinates, it is possible to determine whether an overflow point exists. In other words, using the coordinates, it is determined whether the first DOM element is cut off at the bottom of the first page element (e.g., it does not fit on the page). In this example, an overflow of the first DOM element is detected at 510 in relation to the first page element based, at least in part, on the coordinates.

Responsive to detecting the overflow, the context stack is added to an overflow list and the first page element is modified such that the first DOM element or portion thereof is removed from the first page element at 512. By adding the first context of the first DOM element to the context stack, this enables information about the contexts in which an overflow point is found to be stored and later retrieved. Upon determining that the first DOM element does not fit on the page represented by the first page element, the first DOM element or portion thereof can be removed from the first page element. Stated another way, the first DOM element can be cut off at the position indicated by the overflow index. For example, a first portion of the first DOM element that fits on the first page element may remain, while a second portion of the first DOM element does not fit on the first page element may be removed from the first page element. In addition, a value of a done rendering property of the first DOM element is set (or remains a default value) to indicate rendering of the first DOM element on the page is not completed. For example, the value of the done rendering property of the first DOM element may be set or remain a value of FALSE or 0.

Upon leaving the first DOM element (e.g., after determining that there is no overflow or after adding the context stack to the overflow list), the first context may be popped from the context stack. The remaining DOM elements of the first page element may be traversed to determine whether they fit in the first page element. After all elements of the first page element have been processed, the overflow list can be used to generate the next page element.

It is important to note that the remaining portion of the document fragment (e.g., represented in the page element) is traversed even if an overflow point is detected. In other words, even if one element cannot fit on a page, another element may still be able to fit on the page. Therefore, unlike conventional methods, the web browser may continue to traverse the document fragment within the page element until all elements of the fragment have been traversed.

In accordance with various implementations, the overflow list is applied to initialize the next page. A second page element is generated at 514 based, at least in part, on the overflow list such that the second page element includes the first DOM element, where the second page element represents a second page of the web document. More particularly, each element of the overflow list may be processed, element by element (e.g., FIFO), to add content to the second page element using the set of rules that is relevant to the context type of the context (e.g., context stack) stored in the element of the overflow list.

For a given element of the overflow list, the context stack may be processed item by item in the order indicated by the context stack or, alternatively, by the original DOM or render tree. The value of the done rendering property associated with various elements within the second tree (e.g., the tree being traversed) may be used to further guide the rebuilding process.

For example, if the value of the done rendering property associated with an element is in a first state (e.g., TRUE or 1), that element can be skipped while rebuilding the next page (e.g., page element). However, if the value of the done rendering property associated with an element is in a second state (e.g., FALSE or 0), that element is included in the next page according to the associated set of rules, as described herein.

The overflow list can then be “reset” such that all elements of the overflow list have been removed. The second page element can be added to the first tree and the process can continue as described herein until all of the content of the web document has been paginated (e.g., no remaining overflow is tracked). In this manner, the active render tree may be rebuilt to reflect the correctly paginated web content.

Once the active render tree is rebuilt, the render tree can be traversed to print the web document. For example, the web document can be printed in response to a print command received from a client device in response to a user request.

As discussed above, when multiple overflows are tracked, there is the possibility of accidentally re-rendering the same element multiple times (e.g., on multiple pages or multiple times within the same page) given the nested nature of HTML elements. In some implementations, to solve this problem, during the rebuilding of the first tree (e.g., the active render tree), the value of a done rendering property value corresponding to at least a portion of the DOM elements is set in the second tree (e.g., the tree being traversed) to indicate that rendering is completed for the corresponding DOM element.

FIG. 5B shows a process flow diagram 550 illustrating a method of setting property values of DOM elements in accordance with various implementations. During the traversal of the second tree, a page element including a DOM element of the first tree is generated at 552. For example, the second page element including the second DOM element can be generated. Coordinates of the DOM element (e.g., second DOM element) within the page element (e.g., second page element) are calculated at 554. It is determined at 556 that the DOM element (e.g., according to boundaries of the DOM element) is contained within the page element based, at least in part, on the coordinates of the DOM element. A value of a done rendering property of the DOM element can be set at 558 to a first value (e.g., TRUE or 1) responsive to determining that the DOM element is contained within the boundaries of page element, thereby indicating that rendering for the DOM element is completed. Alternatively, the value of the done rendering property of the DOM element can be set to a second value (e.g., FALSE or 0) responsive to determining that the DOM element is not contained within the boundaries of the page element.

In the above examples, it is assumed that a DOM element has a done rendering property. In some implementations, a done rendering property is maintained for DOM elements of specific types. For those DOM elements that do not have a corresponding done rendering property value, the value of the done rendering property of a parent node may be determined based upon the value of the done rendering property of its children. For example, the done rendering property of a parent may be set to TRUE if the value of the done rendering property of each of its children is set to TRUE. The process may “bubble up” the original (e.g., copy) of the DOM or render tree until an element has a value that indicates that rendering is not completed for that element or the root node is reached.

The disclosed implementations enable a web document having any format or types of DOM elements to be accurately paginated for printing. This is accomplished in part, through the use of a context stack and overflow list. This enables an overflow to be handled in a manner that is unique to the context type or element type for which an overflow point has been detected. Therefore, the disclosed implementations advantageously provide a customizable system that can be configured or updated for a variety of purposes or organizations.

In some implementations, a done rendering property can be set for elements to ensure that elements are not inadvertently repeated on subsequent pages. This eliminates the issues created through simultaneously tracking multiple overflows during pagination of a web document.

Some but not all of the techniques described or referenced herein are implemented using or in conjunction with a database system. Salesforce.com, inc. is a provider of customer relationship management (CRM) services and other database management services, which can be accessed and used in conjunction with the techniques disclosed herein in some implementations. In some but not all implementations, services can be provided in a cloud computing environment, for example, in the context of a multi-tenant database system. Thus, some of the disclosed techniques can be implemented without having to install software locally, that is, on computing devices of users interacting with services available through the cloud. Some of the disclosed techniques can be implemented via an application installed on computing devices of users.

Information stored in a database record can include various types of data including character-based data, audio data, image data, animated images, and/or video data. A database record can store one or more files, which can include text, presentations, documents, multimedia files, and the like. Data retrieved from a database can be presented via a computing device. For example, visual data can be displayed in a graphical user interface (GUI) on a display device such as the display of the computing device. In some but not all implementations, the disclosed methods, apparatus, systems, and computer program products may be configured or designed for use in a multi-tenant database environment.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

Some non-limiting examples of systems, apparatus, and methods are described below for implementing database systems and enterprise level social networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

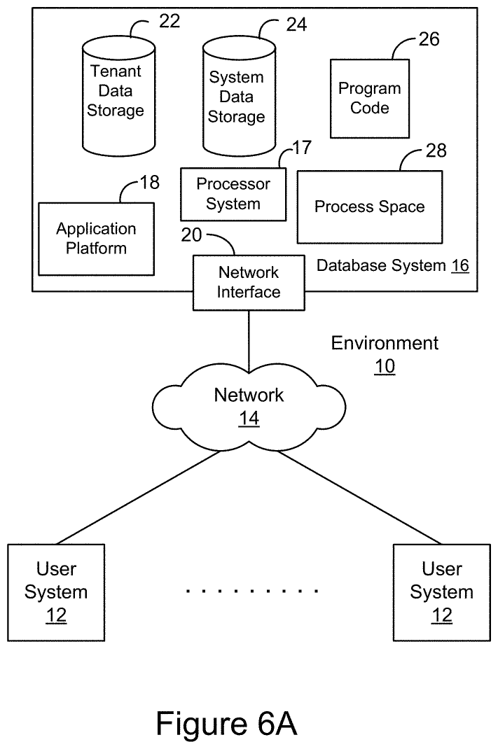

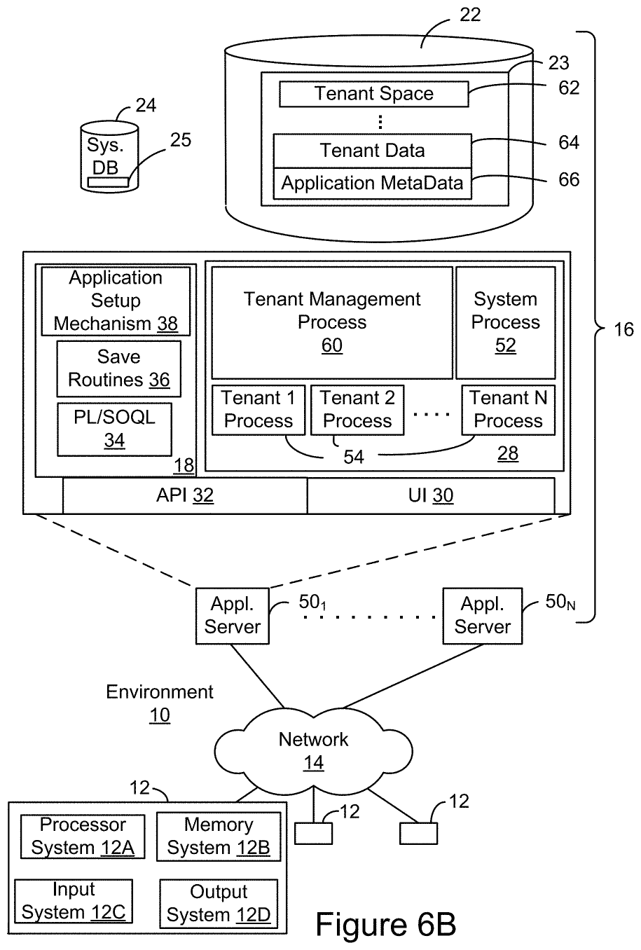

FIG. 6A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 6A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

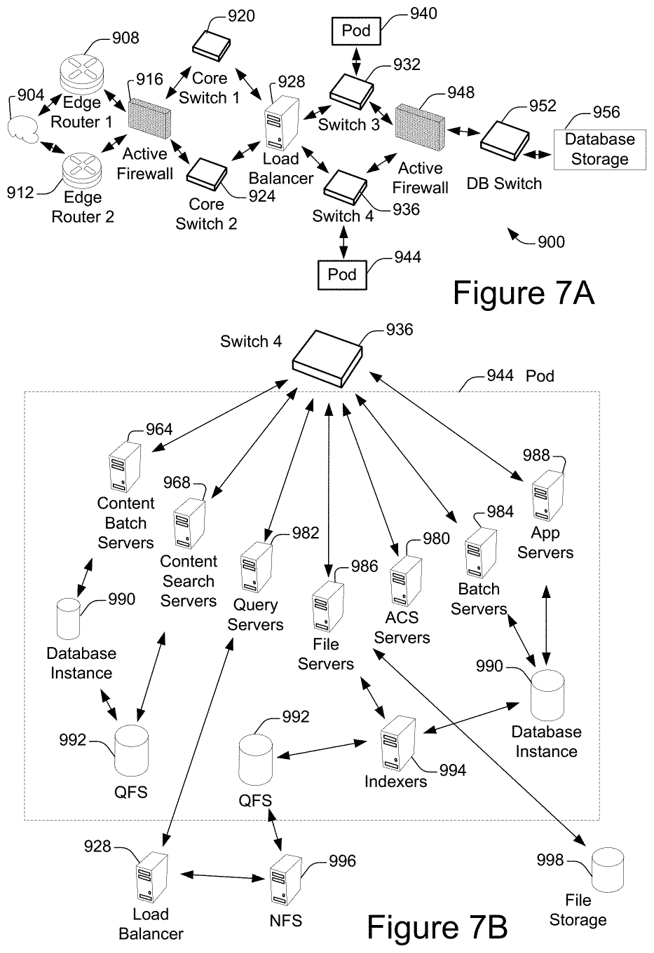

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 7A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 7A and 7B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 7A and 7B, some implementations of an on-demand database service environment may include anywhere from one to many devices of each type. Also, the on-demand database service environment need not include each device shown in FIGS. 7A and 7B, or may include additional devices not shown in FIGS. 7A and 7B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 7A and 7B.

FIG. 7B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 7A and 7B include a hardware and/or software framework configurable to execute procedures using programs, routines, scripts, etc. Thus, in some implementations, one or more of application servers 50₁-50_{N} of FIG. 7B can be configured to initiate performance of one or more of the operations described above by instructing another computing device to perform an operation. In some implementations, one or more application servers 50₁-50_{N} carry out, either partially or entirely, one or more of the disclosed operations. In some implementations, app servers 988 of FIG. 7B support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein. In alternative implementations, two or more app servers 988 may cooperate to perform or cause performance of such operations. Any of the databases and other storage facilities described above with reference to FIGS. 6A, 6B, 7A and 7B can be configured to store lists, articles, documents, records, files, and other objects for implementing the operations described above. For instance, lists of available communication channels associated with share actions for sharing a type of data item can be maintained in tenant data storage 22 and/or system data storage 24 of FIGS. 7A and 7B. By the same token, lists of default or designated channels for particular share actions can be maintained in storage 22 and/or storage 24. In some other implementations, rather than storing one or more lists, articles, documents, records, and/or files, the databases and other storage facilities described above can store pointers to the lists, articles, documents, records, and/or files, which may instead be stored in other repositories external to the systems and environments described above with reference to FIGS. 6A, 6B, 7A and 7B.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

1. A method, comprising:
obtaining a first tree representing a web document, the first tree including one or more Document Object Model (DOM) elements and Cascading Style Sheets (CSS) information pertaining to the DOM elements;
generating a first page element including one or more elements of the first tree, the one or more elements including a first DOM element, the first page element representing a first page of the web document;
calculating coordinates of the first DOM element within the first page element;
pushing a first context associated with the first DOM element onto a context stack;
detecting an overflow of the first DOM element in relation to the first page element based, at least in part, on the coordinates;
responsive to detecting the overflow,
adding the context stack to an overflow list; and
modifying the first page element such that the first DOM element or portion thereof is removed from the first page element; and
generating a second page element based, at least in part, on the overflow list such that the second page element includes the first DOM element, the second page element representing a second page of the web document.

2. The method of claim 1, further comprising:
detaching a document fragment from an active document tree, the first tree including the document fragment;
traversing the first tree;
inserting the first page element in the active document tree; and
inserting the second page element in the active document tree.

3. The method of claim 1, the method further comprising:
determining a first context type of the first DOM element based, at least in part, on a value of at least one Hypertext Markup Language (HTML) property of the first DOM element or a Cascading Style Sheets (CSS) property of the first DOM element, the first context specifying or otherwise indicating the first context type of the first DOM element;
wherein generating the second page element is performed based, at least in part, on a set of rules associated with the first context type.

4. The method of claim 3, the method further comprising:
determining whether to include a non-ancestor DOM element of the first DOM element in the second page element based, at least in part, on the set of rules associated with the first context type.

5. The method of claim 4, the first context identifying the non-ancestor DOM element of the first DOM element.

6. The method of claim 1, the second page element further including a second DOM element of the first tree, the method further comprising:
calculating coordinates of the second DOM element within the second page element;
determining that the second DOM element is contained within the second page element based, at least in part, on the coordinates of the second DOM element; and
setting a value of a done rendering property of the second DOM element responsive to determining that the second DOM element is contained within the second page element; and
determining whether to add the second DOM element to a third page element based, at least in part, on the value of the done rendering property of the second DOM element.

7. The method of claim 1, the first page element further including a second DOM element of the first tree, the method further comprising:
setting a value of a done rendering property of the second DOM element of the first tree based, at least in part, a value of a done rendering property of one or more child elements of the second DOM element; and
determining whether to add the second DOM element to the second page element based, at least in part, on the value of the done rendering property of the second DOM element.

8. A computing system, comprising:
a processor; and
a memory, the computing device configurable to cause:
obtaining, by a web browser of the computing system, a first tree representing a web document, the first tree including one or more DOM elements and Cascading Style Sheets (CSS) information pertaining to the DOM elements;
generating, by the web browser, a first page element including one or more elements of the first tree, the one or more elements including a first DOM element, the first page element representing a first page of the web document;
calculating, by the web browser, coordinates of the first DOM element within the first page element;
pushing, by the web browser, a first context associated with the first DOM element onto a context stack;
detecting, by the web browser, an overflow of the first DOM element in relation to the first page element based, at least in part, on the coordinates;
responsive to detecting the overflow,
adding, by the web browser, the context stack to an overflow list; and
modifying, by the web browser, the first page element such that the first DOM element or portion thereof is removed from the first page element; and
generating, by the web browser, a second page element based, at least in part, on the overflow list such that the second page element includes the first DOM element, the second page element representing a second page of the web document.

9. The computing system of claim 8, the database system further configurable to cause:
detaching a document fragment from an active document tree, the first tree including the document fragment;
traversing the first tree;
inserting the first page element in the active document tree; and
inserting the second page element in the active document tree.

10. The computing system of claim 1, the database system further configurable to cause:
determining a first context type of the first DOM element based, at least in part, on a value of at least one Hypertext Markup Language (HTML) property of the first DOM element or a Cascading Style Sheets (CSS) property of the first DOM element, the first context specifying or otherwise indicating the first context type of the first DOM element;
wherein generating the second page element is performed based, at least in part, on a set of rules associated with the first context type.

11. The computing system of claim 10, the database system further configurable to cause:
determining whether to include a non-ancestor DOM element of the first DOM element in the second page element based, at least in part, on the set of rules associated with the first context type.

12. The computing system of claim 11, the first context identifying the non-ancestor DOM element of the first DOM element.

13. The computing system of claim 8, the second page element further including a second DOM element of the first tree, the database system further configurable to cause:
calculating coordinates of the second DOM element within the second page element;
determining that the second DOM element is contained within the second page element based, at least in part, on the coordinates of the second DOM element; and
setting a value of a done rendering property of the second DOM element responsive to determining that the second DOM element is contained within the second page element; and
determining whether to add the second DOM element to a third page element based, at least in part, on the value of the done rendering property of the second DOM element.

14. The computing system of claim 8, the first page element further including a second DOM element of the first tree, the database system further configurable to cause:
setting a value of a done rendering property of the second DOM element of the first tree based, at least in part, a value of a done rendering property of one or more child elements of the second DOM element; and
determining whether to add the second DOM element to the second page element based, at least in part, on the value of the done rendering property of the second DOM element.

15. A computer program product comprising computer-readable program code capable of being executed by one or more processors when retrieved from a non-transitory computer-readable medium, the program code comprising computer-readable instructions configurable to cause:
obtaining a first tree representing a web document, the first tree including one or more DOM elements and Cascading Style Sheets (CSS) information pertaining to the DOM elements;
generating a first page element including one or more elements of the first tree, the one or more elements including a first DOM element, the first page element representing a first page of the web document;
calculating coordinates of the first DOM element within the first page element;
pushing a first context associated with the first DOM element onto a context stack;
detecting an overflow of the first DOM element in relation to the first page element based, at least in part, on the coordinates;
responsive to detecting the overflow,
adding the context stack to an overflow list; and
modifying the first page element such that the first DOM element or portion thereof is removed from the first page element; and
generating a second page element based, at least in part, on the overflow list such that the second page element includes the first DOM element, the second page element representing a second page of the web document.

16. The computer program product of claim 15, the program code comprising computer-readable instructions further configurable to cause:
detaching a document fragment from an active document tree, the first tree including the document fragment;
traversing the first tree;
inserting the first page element in the active document tree; and
inserting the second page element in the active document tree.

17. The computer program product of claim 15, the program code comprising computer-readable instructions further configurable to cause:
determining a first context type of the first DOM element based, at least in part, on a value of at least one Hypertext Markup Language (HTML) property of the first DOM element or a Cascading Style Sheets (CSS) property of the first DOM element, the first context specifying or otherwise indicating the first context type of the first DOM element;
wherein generating the second page element is performed based, at least in part, on a set of rules associated with the first context type.

18. The computer program product of claim 17, the program code comprising computer-readable instructions further configurable to cause:
determining whether to include a non-ancestor DOM element of the first DOM element in the second page element based, at least in part, on the set of rules associated with the first context type.

19. The computer program product of claim 15, the second page element further including a second DOM element of the first tree, the program code comprising computer-readable instructions further configurable to cause:
calculating coordinates of the second DOM element within the second page element;
determining that the second DOM element is contained within the second page element based, at least in part, on the coordinates of the second DOM element; and
setting a value of a done rendering property of the second DOM element responsive to determining that the second DOM element is contained within the second page element; and
determining whether to add the second DOM element to a third page element based, at least in part, on the value of the done rendering property of the second DOM element.

20. The computer program product of claim 15, the first page element further including a second DOM element of the first tree, the program code comprising computer-readable instructions further configurable to cause:
setting a value of a done rendering property of the second DOM element of the first tree based, at least in part, a value of a done rendering property of one or more child elements of the second DOM element; and
determining whether to add the second DOM element to the second page element based, at least in part, on the value of the done rendering property of the second DOM element.
